(19) United States
(12) Patent Application Publication
(10) Pub. No.: US 2017/0022045 A1
(43) Pub. Date: Jan. 26, 2017

(54) SYSTEM AND METHOD FOR DISPENSING PRODUCT INTO REFILLABLE CONTAINERS

(71) Applicants: Lorna G. Ray, McDonough, GA (US); David N. Ray, McDonough, GA (US)

(72) Inventors: Lorna G. Ray, McDonough, GA (US); David N. Ray, McDonough, GA (US)

(21) Appl. No.: 15/115,756

(22) PCT Filed: Nov. 25, 2014
(86) PCT No.: PCT/US14/67320

§ 371 Date: Aug. 1, 2016

Related U.S. Application Data
(60) Provisional application No. 61/908,222, filed on Nov. 25, 2013.

(51) Int. Cl. B67D 7/34; B67D 7/14; G07F 13/00; B67D 7/74; G06Q 30/02; B67D 7/02; B67D 7/22

(52) U.S. Cl. CPC B67D 7/348; B67D 7/0288; B67D 7/145; B67D 7/224; B67D 7/74; G06Q 30/0255; G07F 13/00

(57) ABSTRACT

Disclosed are various embodiments for dispensing product into refillable containers. A refill station is configured to provide initial fills and refills of a product in a refillable container. The refill station includes a display and a computing device. The computing device is configured to record refill data describing product refills by customers via the refill station. The computing device is further configured to determine one or more environmental impacts saved by the refill station over a use of non-refillable containers based at least in part on the refill data. The computing device is further configured to render the environmental impact(s) upon the display.

### CROSS-REFERENCE TO RELATED APPLICATIONS

This application claims priority to, and the benefit of, U.S. Provisional Application entitled “SYSTEM AND METHOD FOR DISPENSING PRODUCT INTO REFILLABLE CONTAINERS,” filed on Nov. 25, 2013, and assigned Ser. No. 61/908,222, which is incorporated herein by reference in its entirety.

### BACKGROUND

Consumers frequently purchase consumable goods in containers that are intended to be thrown away. Laundry detergents, household cleaners, hair care products, and so on may be sold in plastic containers. After the product contained therein is used, the consumer is either to throw away the container or recycle it. Although recycling is a more environmentally friendly choice, creating and recycling single-use containers has both an environmental cost and a financial cost.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a side view of one example of a refillable container according to an embodiment of the present disclosure.

FIG. 2 is a top view of the refillable container of FIG. 1.

FIG. 3 is a detail view showing the insertion of an injection nozzle of a refill station into a refill port of the refillable container of FIG. 1 according to an embodiment of the present disclosure.

FIG. 4 is a side view of another example of a refillable container according to various embodiments of the present disclosure.

FIG. 5 is a perspective, cut-away view of a refill station according to various embodiments of the present disclosure.

FIG. 6 is a drawing illustrating the use of the refillable container of FIG. 1 in the refill station of FIG. 5 by a customer according to various embodiments of the present disclosure.

FIG. 7 provides a detail view of portions of the refill station of FIG. 5 according to various embodiments of the present disclosure.

FIG. 8 is a schematic block diagram of a networked environment according to various embodiments of the present disclosure.

FIG. 9 is a flowchart illustrating one example of functionality implemented as portions of refill station application executed in a computing device in the networked environment of FIG. 8 according to various embodiments of the present disclosure.

FIG. 10 is a schematic block diagram that provides one example illustration of a computing environment employed in the networked environment of FIG. 8 according to various embodiments of the present disclosure.

### DETAILED DESCRIPTION

The present disclosure relates to a scalable, end-to-end bottle refill system comprised of specially-designed refillable “smart bottles” and corresponding refill stations. Consumers buy a refillable bottle of a product from a store, and whenever it is empty, rather than throw it away and buy a new full bottle, they bring it back to the store to refill it at a refill station. Accordingly, various embodiments of the present disclosure reduce the number of single-use plastic bottles discarded worldwide by making reuse convenient and cost-effective.

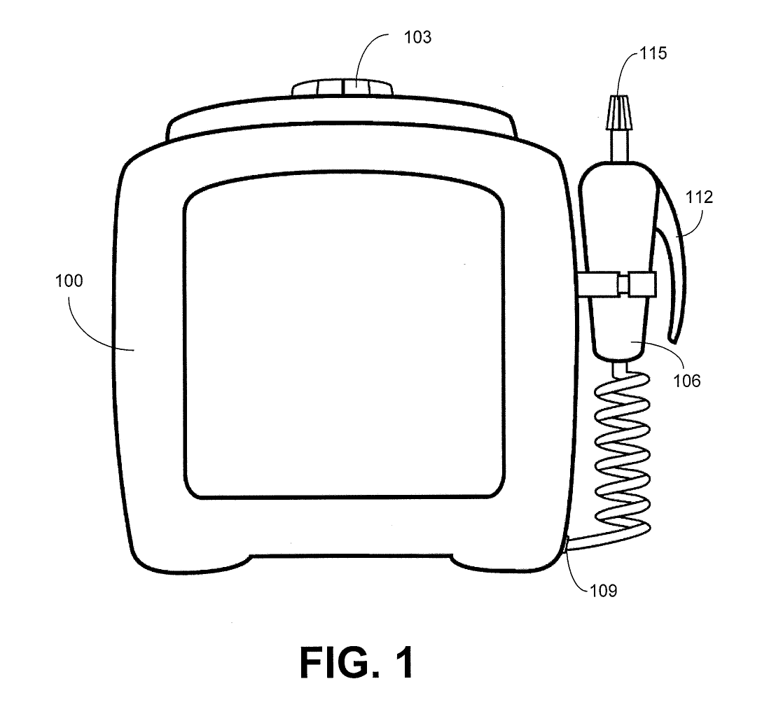

FIG. 1 shows a side view of a non-limiting example of a refillable container 100 according to an embodiment of the present disclosure. The refillable container 100 may be made of plastic, glass, paper, foam, metal, rubber, and/or other materials. According to various embodiments, the refillable container 100 may come in a wide variety of shapes and sizes, depending on the type of product it is designed to contain. For example, the refillable container 100 may include refill ports 103 separate from the openings through which the product is dispensed by the consumer.

The refillable container 100 may include a coiled wand assembly 106 for dispensing product by the consumer. The coiled wand assembly 106 may be coupled to a port 109 located near the bottom of the refillable container 100 for gravity-activated dispensing. The coiled wand assembly 106 may contain a valve 112 that when actuated permits the product in the refillable container 100 to exit the coiled wand assembly via a nozzle 115. For example, the valve 112 may correspond to a button. The coiled wand assembly 106 may include a clip in order to keep the nozzle 115 upright when not in use.

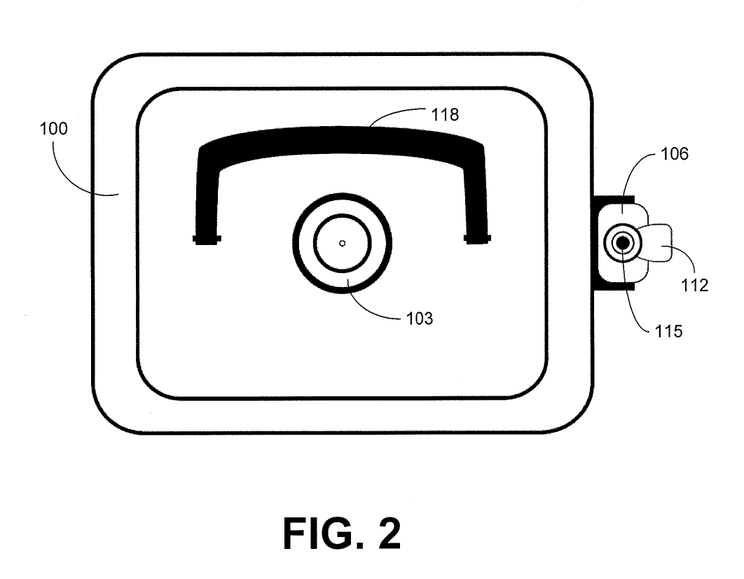

FIG. 2 shows a top view of the refillable container 100 of FIG. 1. As shown, a handle 118 may be present in order to assist in carrying the refillable container 100. In some embodiments, the handle 118 may fold flat against the top of the refillable container 100. In various embodiments, the refill port 103 may correspond to a self-closing penetrable port configured to receive injections of at least one product from a refill station. The self-closing penetrable port may have a rubber, plastic, or similar membrane across the top of the port, with one or more injection points.

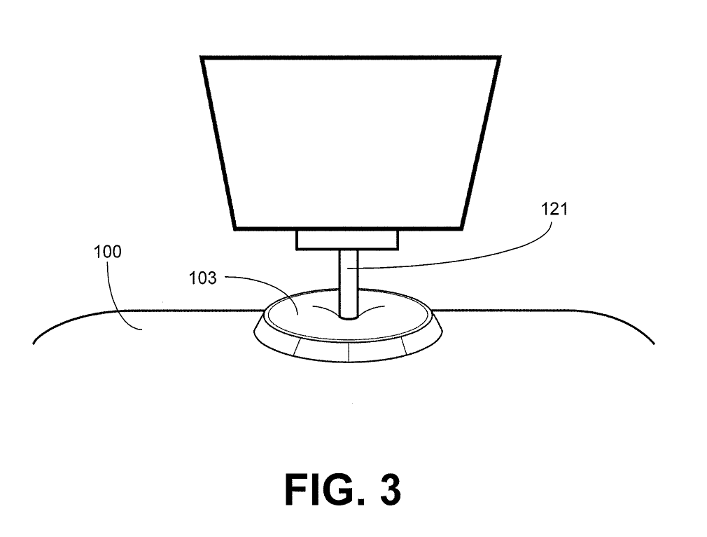

As shown in FIG. 3, an injection nozzle 121 may be placed into the refill port 103 to inject product. However, when the injection nozzle 121 is removed, the refillable container 100 may be turned upside down and no product will leak out. This illustrates the “self-closing” nature of the refill port 103. The refillable container 100 may be refilled via this refill port 103 for a number of times without change in the operation of the refill port 103.

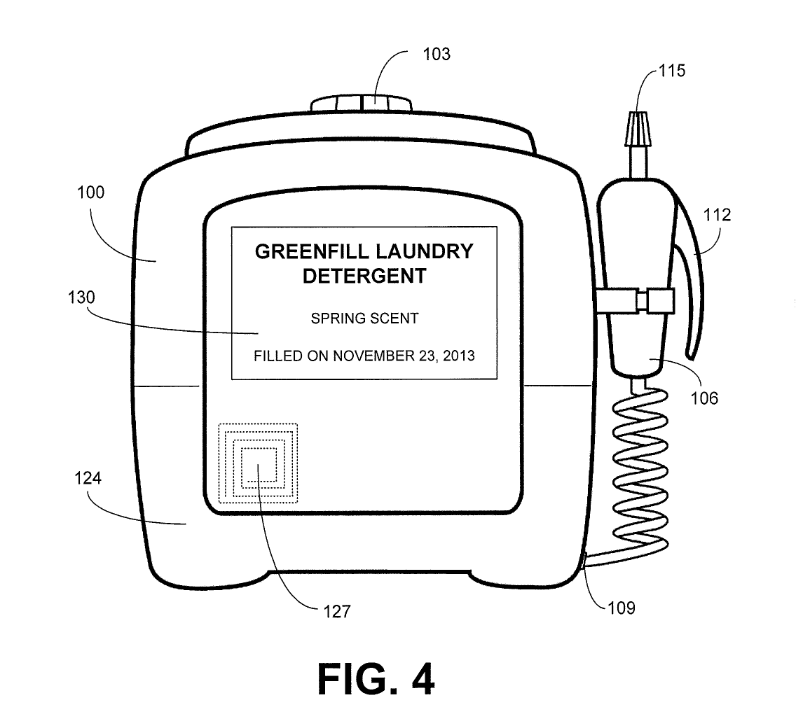

FIG. 4 shows a side view of another non-limiting example of a refillable container 100 illustrating additional features according to various embodiments of the present disclosure. In one embodiment, the refillable container 100 is semi-transparent, so product 124 contained inside is easily visible. Through the use of semi-transparent refillable containers 100, end users can observe when it is time to refill the bottle, and retailers can easily see if the bottle has been refilled and should therefore be rung up at checkout. Thus, the use of semi-transparent bottles may reduce inventory “shrinkage,” whereby a customer dispenses product into the refillable bottle and fails to pay for the product.

In some embodiments, the refillable containers 100 also feature radio-frequency identifier (RFID) chips 127 or other non-volatile memory that may be read and/or written. When a consumer brings a refillable container 100 in for refilling, the refill station's RFID interrogator may record data into the tag identifying what specific product is being filled into the refillable container 100. The next time the refillable container 100 is refilled, the refill station's RFID reader reads this product data, so the refill station will only allow the refillable container 100 to be refilled with identical, similar or compatible products. As a non-limiting example, this will prevent a consumer from accidentally filling shampoo into a bottle previously filled with bleach, the residue from which could harm a human's scalp. In addition to helping ensure safety, the use of RFID chips 127 may also allow manufacturers, distributors, wholesalers, retailers, and/or other interested parties to collect and track data about bottles each time they are purchased and refilled.

In one embodiment, instead of a traditional label, each refillable bottle may feature an ultra-thin, ultra-low power display screen 130. The display screen 130 may comprise organic light emitting diode (OLED) displays, electrophoretic ink (E ink) displays, or other displays. Because the specific product 124 inside the refillable container 100 may change with every refill, the refillable container 100 may display all necessary product information such as brand name, fill date, ingredients and instructions on this electronic label (“e-label”).

Each time the refillable container 100 is refilled with product 124, the refill station transmits to the e-label an image of that product's information, and that image remains stable until the next time the bottle is refilled. This allows everyone to know what product is inside the otherwise unmarked refillable container 100, both when in the store and when using the product 124. Another element transmitted to and displayed on the e-label may be the Universal Product Code (UPC) barcode, which the retailer scans at checkout. In some cases, a quick response (QR) code may be used.

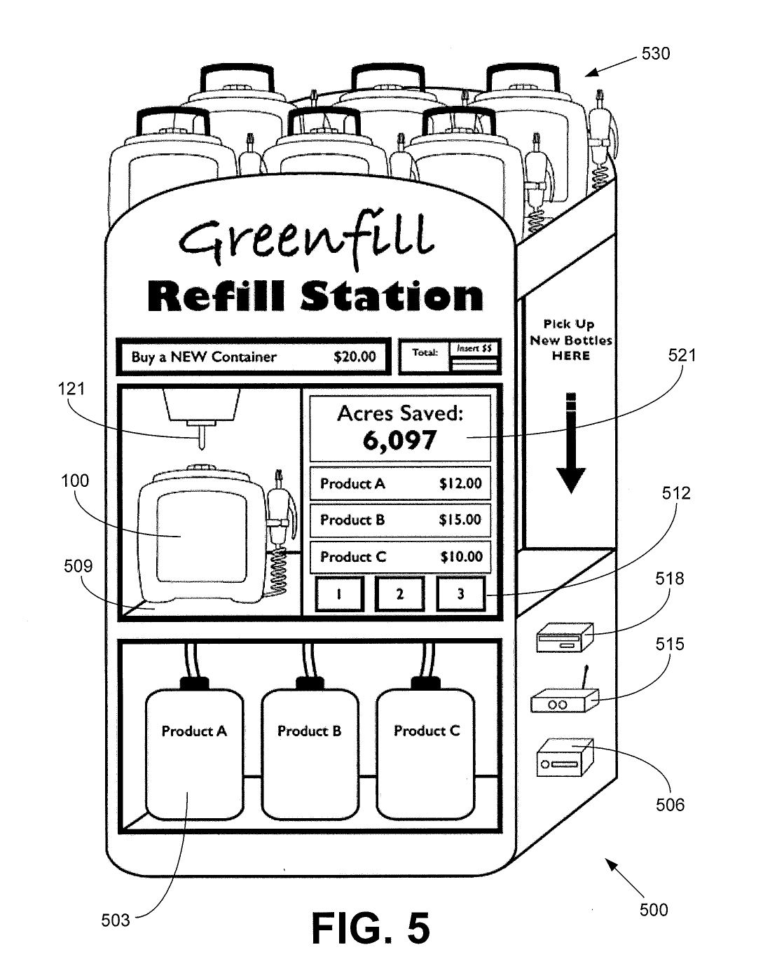

FIG. 5 depicts one example of a refill station 500. As part of a scalable product distribution system, refill stations 500 for the refillable containers 100 may come in a variety of sizes and configurations depending on the requirements of each retailer. In some embodiments, the refillable containers 100 may be uniquely shaped, and the refill station 500 may include interlocks to prevent other containers from be refilled. Refillable containers 100 may also be designed to hold a specific product or series of compatible products. For example, a refillable container 100 for bleach may be uniquely shaped and mating with an interlock in the refill station 500 such that the refill station will not dispense ammonia into the recognized refillable container 100 type for bleach.

Similarly, one type of refillable container 100 may be brand specific (“Brand X”), and the refill station 500 may prevent another brand of the same product (“Brand Y”) from being dispensed in the brand-specific refillable container 100. Refill stations 500 may range in size from small enough to fit on standard retail-store shelves, to larger endcap-sized units, to multi-unit high-capacity dispensing bays. Each refill station 500 may be equipped with a spill-drain system to collect any incidental product spills by customers.

Regardless of unit size, the refill stations 500 may all work in the same way: product is stored in tanks 503 connected to a pump and a dispenser, which are regulated by a dispenser controller 506. Multiple tanks 503 may store different products, such as a standard laundry detergent formula and a high efficiency laundry detergent formula. In some cases, products may be mixed. For example, one tank 503 may store a foundational product (such as a detergent) and other tanks 503 may store additives such as essential oils, etc., that may be mixed with the foundational product to provide a custom blend.

End users put their refillable container 100 into the unit's refill chamber 509, and make their product selection from a menu screen 512. Although the present disclosure emphasizes the refillable nature of the refillable containers 100, it is understood that the refill station 500 may work with single-use containers as well. The RFID reader 515 may identify the previous products filled in that refillable container 100, and if the computing device 518 determines the newly selected product is compatible, the injection nozzle 121 penetrates the refill port 103 (FIG. 1) and fills the refillable container 100 with the selected product. The injection nozzle 121 may feature a sensor that determines when the container is filled, much like a gasoline dispenser for automobiles, which will prevent overfilling in case there was any product remaining in the refillable container 100 when refilling began.

While the refillable container 100 is being filled, the refill station 500 may also transmit product label information to the container's e-label, which updates the image, for example, including the UPC barcode. In some embodiments, the refill station 500 may include a label printer configured to print out a descriptive label of the product being dispensed, where the label may be mechanically attached by the refill station 500 to the refillable container 100, or the label may be manually attached to the refillable container 100 by the user. The station's RFID reader 515 may also write the new product data to the bottle's RFID chip 127 (FIG. 4), updating the record of the contents of the refillable container 100. In some cases, the refillable container 100 may have a permanent label to be used in conjunction with the printed label or e-label. The permanent label may include boilerplate label information such as branding, instructions for use, ingredients, cautions, and/or other information that may apply across multiple products.

In some cases, the identifier of the refillable container 100 may be associated with a unique customer identifier, such that the customer's usage of the refillable container 100 is correlated with the customer's shopping profile, rewards account, etc. In one scenario, the store may be equipped to track the movements of the customer around the store by reading the RFID or other identifier on the bottle while the customer moves about.

Meanwhile, a computing device 518 and server may also update the station's digital display screen 521 to reflect the number of refillable containers 100 refilled at this particular station, as well as potentially a network of refill stations 500 storewide, citywide, statewide, nationwide, worldwide, or according to another geographic area. The graphics on the screen 521 may visually translate this figure into a variety of environmental impacts, including the number of disposable bottles prevented from being dumped into landfills, the number of acres or square miles saved from potential landfilling, energy saved by not manufacturing those disposable bottles, etc. When this process of refilling, labeling and writing data to the chip 127 is complete, end users may then take the full refillable containers 100 to the cashier for checkout. Alternatively, the end user may pay at the refill station 500 with a credit card, debit card, cash, or other payment instruments. In one embodiment, the refill station 500 may physically prevent the end user from removing the refilled refillable container 100 until payment is successfully made.

In some cases, the screen 521 will feature an entertaining animated character who prompts the user to answer questions or make selections. For example, the character may invite first-time buyers to “name” their new refillable container 100. This will create a fun, friendly experience that is customized for each buyer, reinforcing their brand loyalty. Because the customer information and container name may be associated with the unique identifier of the RFID chip 127, the animated character may be able to greet the refillable container 100 and/or customer by name on return visits. For example, a returning customer might hear, “Welcome back, Rachel! Will you be having the usual, or would you like some recommendations for something new?” Customers may also be invited to provide their contact information to receive communications via text message, email, phone call, etc.

In some embodiments, the refill station 500 may implement a customer rewards program. When a particular refill station 500 reaches significant milestones of positive environmental impact (for example, ten acres of landfills prevented, etc.), the current customer may receive a reward for helping save the planet, such as a special coupon, a free gift card, additional free product, and so on. In one embodiment, this may be achieved by the computing device 518 transmitting a special rewards barcode, QR code, or other machine readable identifier on the current container's e-label, which may be scanned at checkout.

As a non-limiting example, suppose a customer peruses the household cleaners aisle and selects a refillable container 100 already pre-filled with “Brand X Original” laundry detergent from the shelf. The RFID chip and the e-label already contain the data indicating what product is inside the refillable container 100. At checkout, a UPC barcode displayed on the e-label or another identifier may be scanned, and the price may include the standard price of the product plus a one-time premium for the extra features of the refillable container 100. The customer then returns home and uses the detergent, and after a month of use, it is easy for him or her to see through the semi-transparent refillable container 100 that the product is nearly gone.

Alternatively, instead of a full refillable container 100, the customer may select an empty one off the shelf. In this case, the RFID chip may contain data indicating the refillable container 100 has never held product, and the e-label may indicate it is empty and may display a distinct UPC barcode or identifier. At checkout, the customer may pay for the empty refillable container 100, but not actual product. In some cases, the refill station 500 may vend empty refillable containers 100 from an inventory 530 in an automated manner. For example, the refill station 500 may include a carousel-style, gravity-fed dispenser that may be able to hold upwards of twenty or more refillable containers 100.

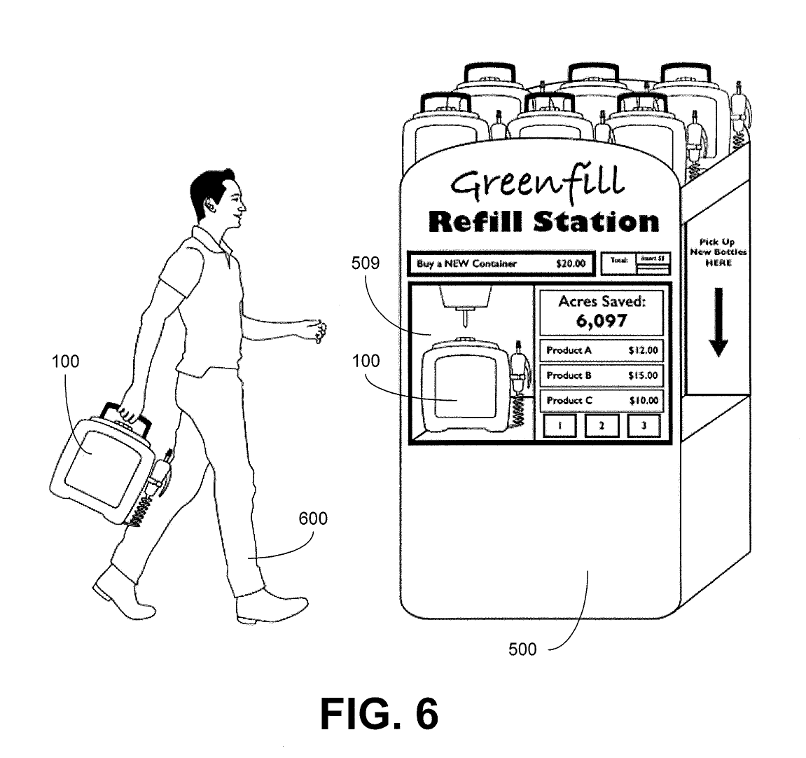

As illustrated in FIG. 6, the customer takes the empty refillable container 100 to any location that features a refill station 500, and puts the bottle into the refill chamber 509. Suppose because of a sale or coupon or because of his or her dissatisfaction with “Brand X Original,” he or she selects “Brand Y Unscented” from the menu screen. The RFID reader 515 (FIG. 5) may read the bottle's chip, and the computing device 518 (FIG. 5) may determine the new product selection is compatible with the container's prior contents (or absence of contents if it was originally purchased empty). For example, various rules may configure which products are compatible with which other products in the refillable container 100. However, if the product were not compatible, the menu screen may alert the customer to make a different selection.

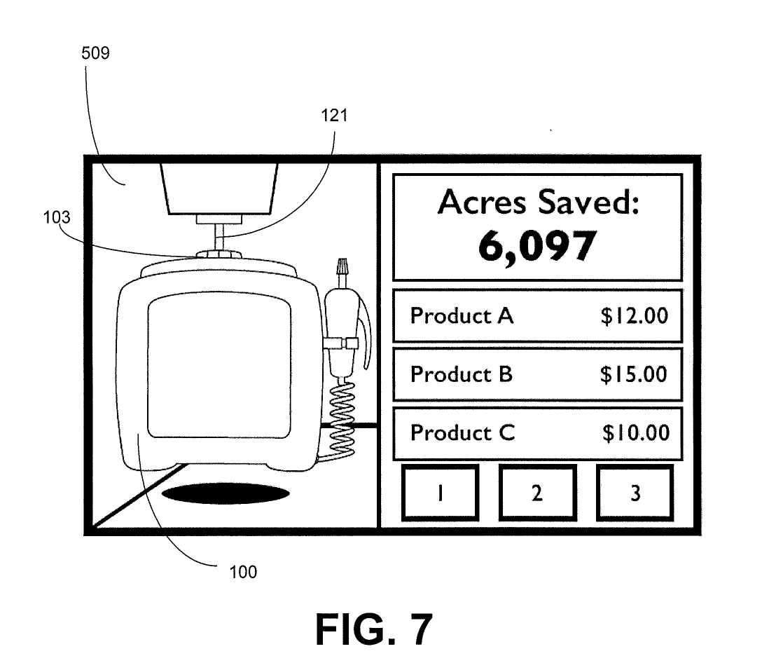

As shown in FIG. 7, the injection nozzle 121 may penetrate the refill port 103 on the refillable container 100 and dispense the product. When the refillable container 100 is filled, or otherwise when sufficient product has been dispensed, the sensor stops the injection nozzle 121 from dispensing more product. The sensor may also detect how much product is in the refillable container 100 before additional product is dispensed in some embodiments.

During the refill process, the computing device 518 may transmit the updated product information to the bottle's e-label, which may update to a new image including the “Brand Y Unscented” logo and promotional information, instructions for use, any required ingredients and warnings, as well as a new UPC barcode or identifier.

During the refill process the customer may investigate the refill station's digital signage to discover the system's positive effects on the environment, such as the updated number of plastic disposable bottles “saved” from landfills, the number of acres saved from landfill development, a measure of petrochemicals saved by not manufacturing disposable containers, etc. When the refill process is finished the customer removes the refillable container 100 from the station's refill chamber 509, puts it in his or her shopping cart and finishes shopping. At checkout, the barcode or other identifier on the e-label may be scanned, and this time the price reflects a discount because the customer is paying only for the product in the refillable container 100, not the refillable container 100 itself. Where the refillable container 100 contained some product to begin with, the customer may pay for the additional product dispensed but not the product remaining in the refillable container 100. From that point, the refill-empty-refill cycle may repeat indefinitely. Refill reminders may be sent automatically to customers based at least in part on a predicted time for a next refill. Incentives may be provided for the customers to return to refill.

The system described herein may be designed for a variety of products, including, for example, laundry detergents, hair care products, household cleaning products, dishwasher detergents, food and beverages, swimming pool chemicals, automotive chemicals, lawn and garden chemicals, dry products, liquid products, and/or other products. The smart bottle technology described herein may be employed for a variety of different types of containers, including, for example, smart water/soda bottles, smart coffee pots/cups, smart milk jugs, smart cereal boxes, smart paint cans, smart gas cans/motor oil bottles, smart propane tanks, smart herbicide containers, and other containers. Examples of data stored in the bottle's memory and displayed on e-labels may include origination and refill contents, origination and refill dates, origination and refill locations, purchase prices, cleaning/sanitation dates, storage temperatures, nutritional data, and/or other information.

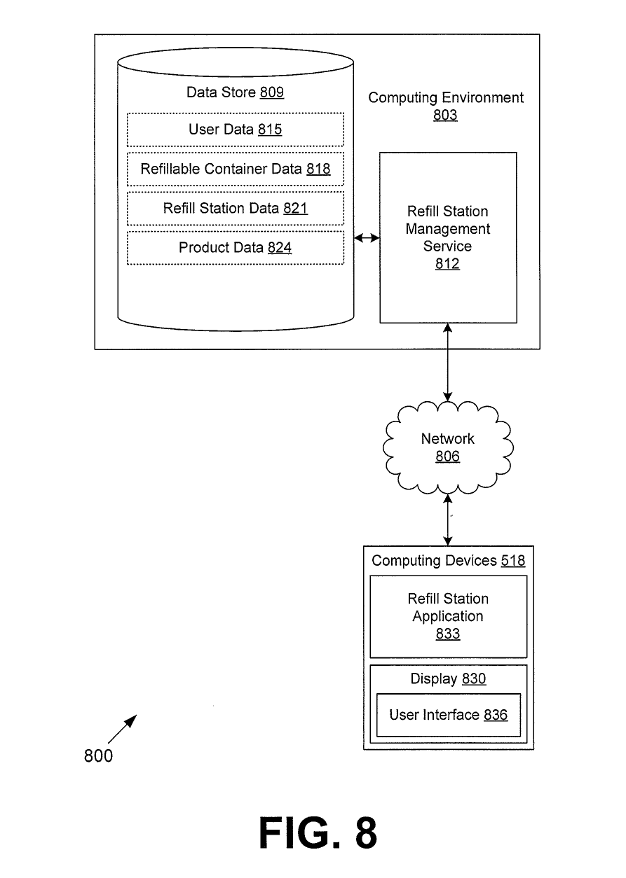

With reference to FIG. 8, shown is a networked environment 800 according to various embodiments. The networked environment 800 includes a computing environment 803 and a plurality of computing devices 518, which are in data communication with each other via a network 806. The network 806 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 803 may comprise, for example, a server computer or any other system providing computing capability. Alternatively, the computing environment 803 may employ a plurality of computing devices that may be arranged, for example, in one or more server banks or computer banks or other arrangements. Such computing devices may be located in a single installation or may be distributed among many different geographical locations. For example, the computing environment 803 may include a plurality of computing devices that together may comprise a hosted or “cloud” computing resource, a grid computing resource, and/or any other distributed computing arrangement. In some cases, the computing environment 803 may correspond to an elastic computing resource where the allotted capacity of processing, network, storage, or other computing-related resources may vary over time.

Various applications and/or other functionality may be executed in the computing environment 803 according to various embodiments. Also, various data is stored in a data store 809 that is accessible to the computing environment 803. The data store 809 may be representative of a plurality of data stores 809 as can be appreciated. The data stored in the data store 809, for example, is associated with the operation of the various applications and/or functional entities described below.

The components executed on the computing environment 803, for example, include a refill station management service 812 and other applications, services, processes, systems, engines, or functionality not discussed in detail herein. The refill station management service 812 is executed to provide management, user tracking, container tracking, and/or other functions for a network of refill stations 500 (FIG. 5). The refill station management service 812 may receive data communications from the refill stations 500 reporting container sales, refills, customer information, and/or other information. In return, the refill station management service 812 may provide information to the refill stations 500 to facilitate purchases and/or refills, prevent incompatible products from being dispensed, and/or for other purposes.

The data stored in the data store 809 includes, for example, user data 815, refillable container data 818, refill station data 821, product data 824, and potentially other data. The user data 815 may track data relating to various users of the system including contact information (e.g., phone numbers, email addresses, mailing addresses, etc.), names, associated refillable containers 100 (FIG. 1), visits to refill stations 500, and/or other information.

The refillable container data 818 may include various information associated with refillable containers 100, including refill history, fill locations, fill names, products and product mixtures, bottle name, associated customers, and/or other information. The refill station data 821 may record containers sold, product dispensed, and/or other information. The product data 824 may indicate various compatibilities or incompatibilities between products, ingredients, pricing, label information, and/or other information.

The computing devices 518 are representative of a plurality of devices in refill stations 500 that may be coupled to the network 806. The computing devices 518 may comprise, for example, a processor-based system such as a computer system. The computing device 518 may include a display 830. The display 830 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The computing device 518 may be configured to execute various applications such as a refill station application 833 and/or other applications. The refill station application 833 may be executed in a computing device 518 to perform operational functions for a given refill station 500. The refill station application 833 may render various user interfaces 836 upon the display 830.

The operational functions performed by the refill station application 833 may include notifying the refill station management service 812 when product supply or container inventory is low, coordinating sale and dispensing of refillable containers 100, coordinating sale and dispensing of products and product mixtures, reporting sale information to the refill station management service 812, obtaining payment instrument information and processing payments, rendering a user interface 836 to encourage users to make a purchase or refill and/or facilitate a purchase or refill, reading identifiers of the refillable containers 100, writing information to the identifiers of the refillable containers 100, printing labels and/or updating e-labels, obtaining customer information and reporting it to the refill station management service 812, and/or other functions.

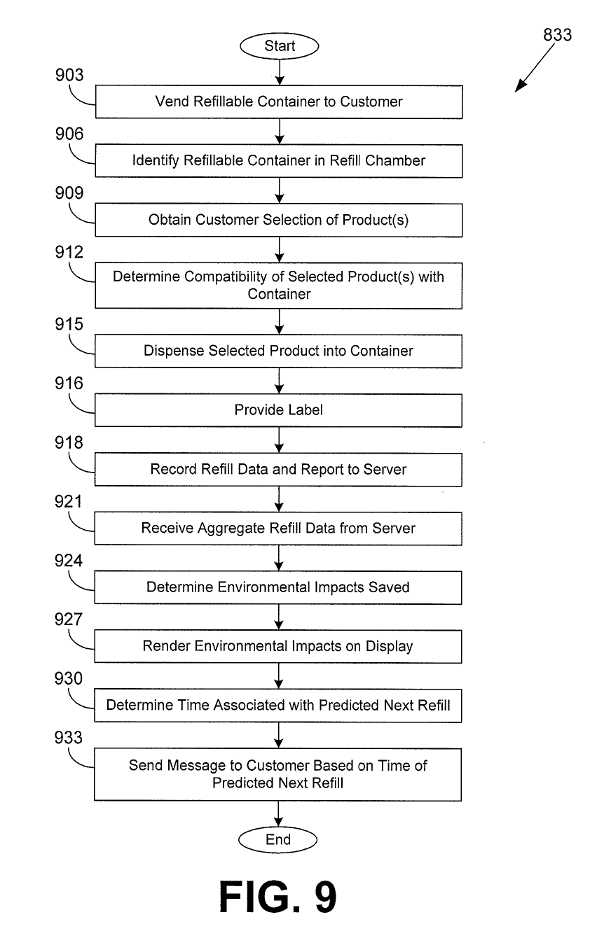

Referring next to FIG. 9, shown is a flowchart that provides one example of the operation of a portion of the refill station application 833 according to various embodiments. It is understood that the flowchart of FIG. 9 provides merely an example of the many different types of functional arrangements that may be employed to implement the operation of the portion of the refill station application 833 as described herein. As an alternative, the flowchart of FIG. 9 may be viewed as depicting an example of elements of a method implemented in the computing device 518 (FIG. 8) according to one or more embodiments.

Beginning with box 903, the refill station application 833 vends a refillable container 100 (FIG. 1) from an inventory 530 (FIG. 5). In box 906, the refill station application 833 identifies a refillable container 100 presented in a refill chamber 509 (FIG. 7). For example, the refill station application 833 may scan a barcode, QR code, RFID tag, and/or other unique identifier of the refillable container 100. If the refillable container 100 is previously presented, the refill station application 833 may render a greeting based upon the name of the refillable container 100, the name of the customer, and/or other information.

In box 909, the refill station application 833 obtains a customer selection of one or more products. For example, the customer may select high-efficiency laundry detergent as a foundational product, with a peppermint essential oil additive to be mixed in for scent. In box 912, the refill station application 833 determines the compatibility of the selected product(s) with the refillable container 100. For example, the selected product(s) may be incompatible with products previously stored in the refillable container 100. Alternatively, the refillable container 100 may be designated as not compatible for the selected product(s). If the product(s) are not compatible with the refillable container 100, the refill station application 833 may prompt the customer to present another refillable container 100 or make another product selection.

In box 915, the refill station application 833 dispenses the selected product(s) into the presented refillable container 100. In some cases, the customer may specify a certain amount of product be dispensed. Alternatively, the refill station application 833 may dispense the product until the refillable container 100 is sensed to be full, potentially giving a credit for product still in the refillable container 100. The refill station application 833 may cause multiple products to be mixed before injecting a mixture, or the refill station application 833 may cause multiple products to be injected together into the refillable container 100.

In box 916, the refill station application 833 causes a label to be printed. In some cases, the refill station application 833 may cause the label to be mechanically affixed to the refillable container 100 in the refill chamber 509. In some cases, the refill station application 833 may cause an e-label of the refillable container 100 to be updated with information about the dispensed product.

In box 918, the refill station application 833 records data associated with the refill and potentially reports it to the refill station management service 812 (FIG. 8). In box 912, the refill station application 833 may receive aggregate refill data and/or other information from the refill station management service 812. In box 924, the refill station application 833 determines environmental impacts saved over the use of non-refillable containers. The environmental impacts may correspond to environmental impacts saved by just the present refill station 500 or an aggregate environmental impact saved by a network of refill stations 500. The environmental impacts may correspond, for example, to a landfill savings metric, a container production savings metric, and/or other metrics. In box 927, the refill station application 833 renders the environmental impacts upon the display 830 (FIG. 8).

In box 930, the refill station application 833 determines a time associated with a predicted next refill of the refillable container 100. In box 933, the refill station application 833 sends a message to the customer based at least in part on the time associated with the predicted next refill. In one example, this message may include a reminder for a next refill, potentially with a financial incentive for the user to refill the refillable container 100. In some cases, this functionality may be performed by the refill station management service 812 rather than the refill station application 833. Thereafter, the portion of the refill station application 833 ends.

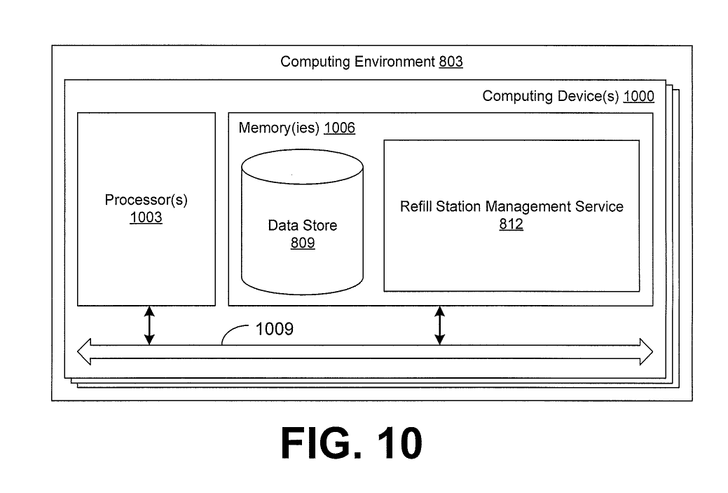

With reference to FIG. 10, shown is a schematic block diagram of the computing environment 803 according to an embodiment of the present disclosure. The computing environment 803 includes one or more computing devices 1000. Each computing device 1000 includes at least one processor circuit, for example, having a processor 1003 and a memory 1006, both of which are coupled to a local interface 1009. To this end, each computing device 1000 may comprise, for example, at least one server computer or like device. The local interface 1009 may comprise, for example, a data bus with an accompanying address/control bus or other bus structure as can be appreciated.

Stored in the memory 1006 are both data and several components that are executable by the processor 1003. In particular, stored in the memory 1006 and executable by the processor 1003 is the refill station management service 812 and potentially other applications. Also stored in the memory 1006 may be a data store 809 and other data. In addition, an operating system may be stored in the memory 1006 and executable by the processor 1003.

It is understood that there may be other applications that are stored in the memory 1006 and are executable by the processor 1003 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1006 and are executable by the processor 1003. In this respect, the term “executable” means a program file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, performing load balancing. The processor 1003 may be of electrical or of some other available construction.

Although the refill station management service 812, the refill station application 833, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 9 shows the functionality and operation of an implementation of portions of the refill station application 833. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1003 in a computer system or other system. The machine code may be converted from the source code, etc. If embodied in hardware, each block may represent a circuit or a number of interconnected circuits to implement the specified logical function(s).

Although the flowchart of FIG. 9 shows a specific order of execution, it is understood that the order of execution may differ from that which is depicted. For example, the order of execution of two or more blocks may be scrambled relative to the order shown. Also, two or more blocks shown in succession in FIG. 9 may be executed concurrently or with partial concurrence. Further, in some embodiments, one or more of the blocks shown in FIG. 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the refill station management service 812 and the refill station application 833, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the refill station management service 812 and the refill station application 833, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1000, or in multiple computing devices in the same computing environment 803. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The above disclosure may be described by at least the following clauses:

1. A refill station configured to provide initial fills and refills of a product in a refillable container, the refill station comprising: a display; and a computing device configured to at least: record refill data describing a plurality of product refills by a plurality of customers via the refill station; determine at least one environmental impact saved by the refill station over a use of non-refillable containers based at least in part on the refill data; and render the at least one environmental impact upon the display.

2. The refill station of clause 1, further comprising a printer configured to print an adhesive label bearing an identification of the product being dispensed into the refillable container.

3. The refill station of clause 1, wherein the refill station is configured to dispense the product into the refillable container via a self-closing penetrable port of the refillable container.

4. The refill station of clause 3, wherein the refillable container includes a coiled wand tool configured to dispense the product from the refillable container, the coiled wand tool receiving the product via a port different from the self-closing penetrable port.

5. The refill station of clause 1, wherein the refill station includes an inventory of a plurality of refillable containers, and the refill station is configured to vend the refillable container to a customer from the inventory.

6. The refill station of clause 1, wherein the computing device is further configured to at least: report the refill data to a server; receive aggregate refill data from the server; determine at least one aggregate environmental impact saved by a network of refill stations over the use of non-refillable containers based at least in part on the aggregate refill data; and render that at least one aggregate environmental impact upon the display.

7. The refill station of clause 1, wherein the at least one environmental impact comprises to a landfill savings metric.

8. The refill station of clause 1, wherein the at least one environmental impact comprises a container production savings metric.

9. The refill station of clause 1, wherein the refill station is configured to fill a selected one of a plurality of products in a user-provided refillable container, and the computing device is further configured to at least receive a user selection of the selected one of the plurality of products.

10. The refill station of clause 9, wherein the computing device is further configured to: read a unique identifier from the user-provided refillable container; and determine that the selected one of the plurality of products is compatible with a previously filled one of the plurality of products based at least in part on container fill history data corresponding to the unique identifier and product compatibility data.

11. The refill station of clause 10, wherein the product compatibility data indicates that a first one of the plurality of products is compatible with a second one of the plurality of products, but also that the first one of the plurality of products is not compatible with a third one of the plurality of products.

12. The refill station of clause 9, wherein the selected one of the plurality of products comprises a mixture of a first one of the plurality of products with a second one of the plurality of products, the mixture being performed in the refill station.

13. The refill station of clause 12, wherein the first one of the plurality of products is a detergent product, and the second one of the plurality of products is an essential oil product.

14. A refillable container, comprising: a self-closing penetrable port at or near a top of the refillable container configured to receive injections of at least one product from a refill station; and a coiled wand dispensing tool configured to dispense the at least one product from the refillable container via a port at or near a bottom of the refillable container.

15. The refillable container of clause 14, further comprising a radio-frequency identifier bearing a unique identifier, wherein the refill station is configured to associate the unique identifier with an identification of the at least one product.

16. The refillable container of clause 14, further comprising an electronic ink display configured to render an identification of the at least one product, the electronic ink display being updated in response to an interaction with the refill station.

17. A method, comprising: scanning a unique identifier of a refillable container when presented to a refill station; filling the refillable container with a product by the refill station; determining a time associated with a predicted next refill of the product into the refillable container; and sending a message to a customer associated with the unique identifier based at least in part on the time associated with the predicted next refill.

18. The method of clause 17, wherein the message includes a code associated with at least one financial incentive for the customer to refill the refillable container.

19. The method of clause 17, wherein sending the message further comprises sending an email message to an email address associated with the unique identifier.

20. The method of clause 17, wherein sending the message further comprises sending a text message to a phone number associated with the unique identifier.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A refill station configured to provide initial fills and refills of a product in a refillable container, the refill station comprising:
a display; and
a computing device configured to at least:
record refill data describing a plurality of product refills by a plurality of customers via the refill station;
determine at least one environmental impact saved by the refill station over a use of non-refillable containers based at least in part on the refill data; and
render the at least one environmental impact upon the display.

2. The refill station of claim 1, further comprising a printer configured to print an adhesive label bearing an identification of the product being dispensed into the refillable container.

3. The refill station of claim 1, wherein the refill station is configured to dispense the product into the refillable container via a self-closing penetrable port of the refillable container.

4. The refill station of claim 3, wherein the refillable container includes a coiled wand tool configured to dispense the product from the refillable container, the coiled wand tool receiving the product via a port different from the self-closing penetrable port.

5. The refill station of claim 1, wherein the refill station includes an inventory of a plurality of refillable containers, and the refill station is configured to vend the refillable container to a customer from the inventory.

6. The refill station of claim 1, wherein the computing device is further configured to at least:
report the refill data to a server;
receive aggregate refill data from the server;
determine at least one aggregate environmental impact saved by a network of refill stations over the use of non-refillable containers based at least in part on the aggregate refill data; and
render that at least one aggregate environmental impact upon the display.

7. The refill station of claim 1, wherein the at least one environmental impact comprises to a landfill savings metric.

8. The refill station of claim 1, wherein the at least one environmental impact comprises a container production savings metric.

9. The refill station of claim 1, wherein the refill station is configured to fill a selected one of a plurality of products in a user-provided refillable container, and the computing device is further configured to at least receive a user selection of the selected one of the plurality of products.

10. The refill station of claim 9, wherein the computing device is further configured to:
read a unique identifier from the user-provided refillable container; and
determine that the selected one of the plurality of products is compatible with a previously filled one of the plurality of products based at least in part on container fill history data corresponding to the unique identifier and product compatibility data.

11. The refill station of claim 10, wherein the product compatibility data indicates that a first one of the plurality of products is compatible with a second one of the plurality of products, but also that the first one of the plurality of products is not compatible with a third one of the plurality of products.

12. The refill station of claim 9, wherein the selected one of the plurality of products comprises a mixture of a first one of the plurality of products with a second one of the plurality of products, the mixture being performed in the refill station.

13. The refill station of claim 12, wherein the first one of the plurality of products is a detergent product, and the second one of the plurality of products is an essential oil product.

14. A refillable container, comprising:
a self-closing penetrable port at or near a top of the refillable container configured to receive injections of at least one product from a refill station; and
a coiled wand dispensing tool configured to dispense the at least one product from the refillable container via a port at or near a bottom of the refillable container.

15. The refillable container of claim 14, further comprising a radio-frequency identifier bearing a unique identifier, wherein the refill station is configured to associate the unique identifier with an identification of the at least one product.

16. The refillable container of claim 14, further comprising an electronic ink display configured to render an identification of the at least one product, the electronic ink display being updated in response to an interaction with the refill station.

17. A method, comprising:
scanning a unique identifier of a refillable container when presented to a refill station;
filling the refillable container with a product by the refill station;
determining a time associated with a predicted next refill of the product into the refillable container; and
sending a message to a customer associated with the unique identifier based at least in part on the time associated with the predicted next refill.

18. The method of claim 17, wherein the message includes a code associated with at least one financial incentive for the customer to refill the refillable container.

19. The method of claim 17, wherein sending the message further comprises sending an email message to an email address associated with the unique identifier.

20. The method of claim 17, wherein sending the message further comprises sending a text message to a phone number associated with the unique identifier.
